(19) United States
(12) Patent Application Publication
(10) Pub. No.: US 2024/0268617 A1
(43) Pub. Date: Aug. 15, 2024

(54) CLEANER HEAD AND CLEANER COMPRISING SAME

(71) Applicant: Samsung Electronics Co., Ltd., Suwon-si (KR)

(72) Inventors: Byoungin LEE, Suwon-si (KR); Taegwang KIM, Suwon-si (KR); Jiwon CHOI, Suwon-si (KR); Dongwoo HA, Suwon-si (KR)

(21) Appl. No.: 18/643,443

(22) Filed: Apr. 23, 2024

Related U.S. Application Data
(63) Continuation of application No. PCT/KR2022/016945, filed on Nov. 1, 2022.

(30) Foreign Application Priority Data
Dec. 23, 2021 (KR) 10-2021-0186589

(51) Int. Cl. A47L 9/28; A46B 13/00; A46B 13/02; A47L 9/04

(52) U.S. Cl. CPC A47L 9/2889; A46B 13/001; A46B 13/02; A47L 9/0411; A47L 9/0477

(57) ABSTRACT

A cleaner head is provided. The cleaner head includes a brush drum rotatable about a rotation axis, a brush case rotatably supporting the brush drum, and a drive assembly arranged inside the brush drum and configured to provide a rotational force to the brush drum, wherein the drive assembly includes a drive motor, a drive housing that accommodates the drive motor, is arranged between an inner circumferential surface of the brush drum and an outer circumferential surface of the drive motor, and is supported by an end of the brush case, a thermostat that is configured to cut off power supplied to the drive motor according to a temperature, and is arranged to be spaced apart from the drive motor in a direction of the rotation axis, and a heat transfer structure configured to transfer heat from the drive motor to the thermostat.

### CROSS-REFERENCE TO RELATED APPLICATION(S)

This application is a continuation application, claiming priority under § 365(c), of an International application No. PCT/KR2022/016945, filed on Nov. 1, 2022, which is based on and claims the benefit of a Korean patent application number 10-2021-0186589, filed on Dec. 23, 2021, in the Korean Intellectual Property Office, the disclosure of which is incorporated by reference herein in its entirety.

### BACKGROUND

### 1. Field

The disclosure relates to a cleaner head and a cleaner.

### 2. Description of Related Art

In general, a cleaner is a home appliance that sucks in air containing foreign substances, such as dust, by using a negative (−) pressure generated by a motor assembly mounted inside a main body of the cleaner, and then filters out foreign substances from the inside of the main body.

In order to supplement the suction force of the cleaner, a cleaner head is provided with a brush drum that rotates to repeatedly contact a floor surface. In the cleaner head, a drive motor for driving the brush drum may be arranged separately from a motor assembly, which is a main motor.

During a cleaning process with a cleaner, the load applied to the brush drum increases depending on the condition of a floor, and accordingly, the drive motor may overheat. When the drive motor overheats, a fire may occur in the drive motor or its peripheral components, or the drive motor may be damaged.

Based on such an issue due to overheating of the drive motor, a thermostat may be used to cut off power supplied to the drive motor according to the temperature of the drive motor. However, when the thermostat is attached to the surface of the drive motor, the size of the brush drum may increase due to the thickness of the thermostat.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide to a cleaner head and a cleaner.

Additional aspects will be set forth in part in the description which follows and, in part, will be apparent from the description, or may be learned by practice of the presented embodiments.

In accordance with an aspect of the disclosure, a cleaner head is provided. The cleaner head includes a brush drum rotatable about a rotation axis, a brush case rotatably supporting the brush drum, and
a drive assembly arranged inside the brush drum and configured to provide a rotational force to the brush drum wherein the drive assembly includes a drive motor, a drive housing that accommodates the drive motor, is arranged between an inner circumferential surface of the brush drum and an outer circumferential surface of the drive motor, and is supported by an end of the brush case, a thermostat that is configured to cut off power supplied to the drive motor according to a temperature, and is arranged to be spaced apart from the drive motor in a direction of the rotation axis, and a heat transfer structure configured to transfer heat from the drive motor to the thermostat.

In accordance with another aspect of the disclosure, a cleaner is provided. The cleaner includes a cleaner main body, and a cleaner head connected to the cleaner main body, wherein the cleaner head includes a brush drum rotatable about a rotation axis, a brush case rotatably supporting the brush drum, and a drive assembly arranged inside the brush drum and configured to provide a rotational force to the brush drum, and wherein the drive assembly includes a drive motor, a drive housing that accommodates the drive motor, is arranged between an inner circumferential surface of the brush drum and an outer circumferential surface of the drive motor, and is supported by an end of the brush case, and a thermostat that is configured to cut off power supplied to the drive motor according to a temperature, and is arranged to be spaced apart from the drive motor in a direction of the rotation axis, and a heat transfer structure configured to transfer heat from the drive motor to the thermostat.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a cleaner according to an embodiment of the disclosure;

FIG. 2 is a perspective view of an assembled cleaner head according to an embodiment of the disclosure;

FIG. 3 is an exploded perspective view of a cleaner head according to an embodiment of the disclosure;

FIG. 4 is a cross-sectional view of a cleaner head of FIG. 3 according to an embodiment of the disclosure;

FIG. 5 is a perspective view illustrating a drive assembly according to an embodiment of the disclosure;

FIG. 6 is a cross-sectional view of a drive assembly of FIG. 5 according to an embodiment of the disclosure;

FIG. 7 is an exploded perspective view of a drive assembly of FIG. 5 according to an embodiment of the disclosure;

FIG. 8 is an enlarged view of a portion of FIG. 6 according to an embodiment of the disclosure;

FIG. 9 is a perspective view of a heat transfer structure of FIG. 7 viewed from another angle according to an embodiment of the disclosure;

FIG. 10 is a diagram illustrating a path of heat transfer by a heat transfer structure according to an embodiment of the disclosure;

FIGS. 11 and 12 are perspective views illustrating a process of assembling a heat transfer structure to a drive housing according to various embodiments of the disclosure;

FIG. 13 is a diagram illustrating a coupling area and a second coupling area according to an embodiment of the disclosure; and

FIG. 14 is a diagram illustrating coupling areas and a second coupling area according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms, such as “first” or “second” may be used to describe various elements, but the elements are not limited by the terms. These terms are only used to distinguish one element from another element. For example, a first element may be referred to as a second element, and a second element may be referred to as a first element in a similar manner, without departing from the scope of the disclosure. The term “and/or” includes any and all combinations of one or more of the associated listed items.

Terms used herein are for describing embodiments and are not intended to limit the scope of the disclosure. Singular forms are intended to include plural forms as well, unless the context clearly indicates otherwise. In the disclosure, it is to be understood that the terms, such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Like reference numerals in the drawings indicate members that perform substantially the same functions.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

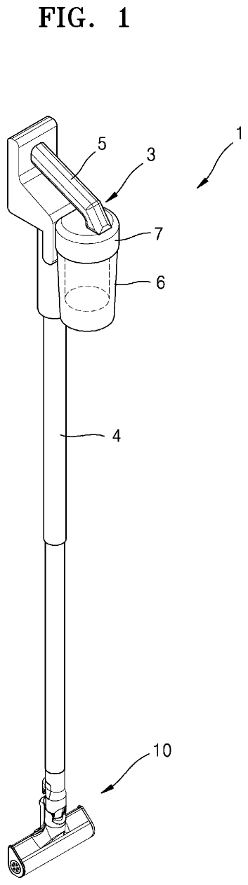

FIG. 1 is a diagram illustrating a cleaner according to an embodiment of the disclosure.

Referring to FIG. 1, a cleaner 1 according to an embodiment of the disclosure may include a cleaner main body 3 and a cleaner head 10 connected to the cleaner main body 3. The cleaner 1 may include a suction pipe 4 connecting the cleaner main body 3 to the cleaner head 10, and a handle part 5 connected to the cleaner main body 3. The cleaner 1 may be a cordless cleaner, but is not limited thereto and may be a corded cleaner.

The cleaner main body 3 may include a dust container 6 and a drive unit 7 both provided therein. The dust container 6 may store dust or dirt on a surface being cleaned, which is sucked in from the cleaner head 10. The dust container 6 may be detachably connected to the cleaner main body 3, and may be separated according to the convenience of a user.

The drive unit 7 may include a motor assembly (not shown) configured to drive the cleaner 1. The motor assembly generates a suction force inside the cleaner main body 3.

The cleaner head 10 is provided to suck in foreign substances on a surface to be cleaned, such as dust, while moving in contact with the surface to be cleaned. The cleaner head 10 may be connected to one end of the suction pipe 4.

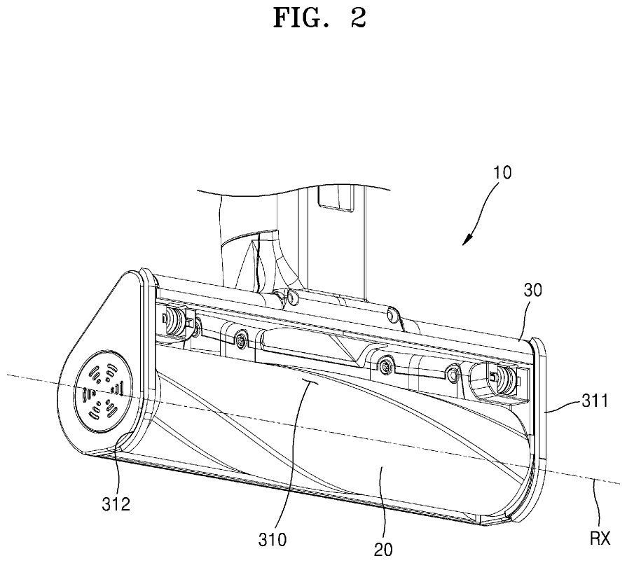

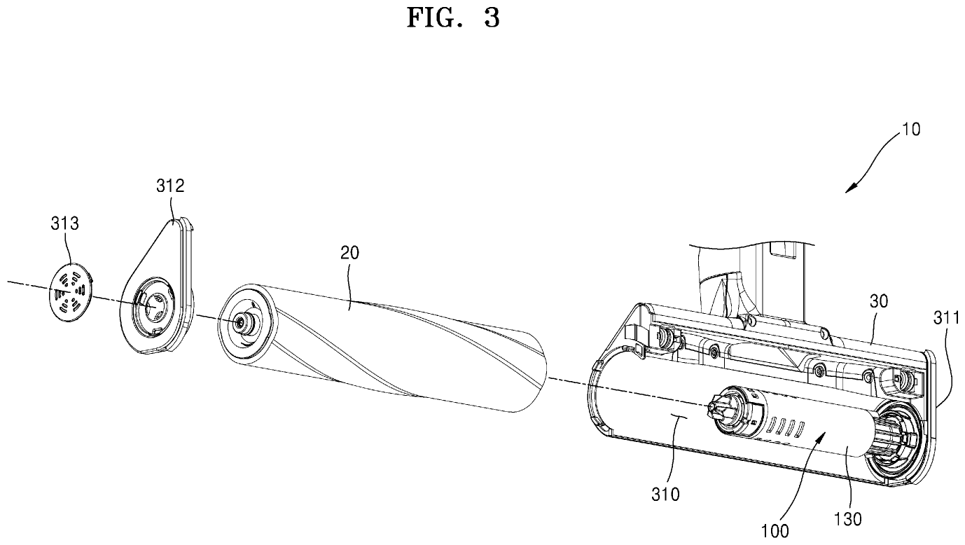

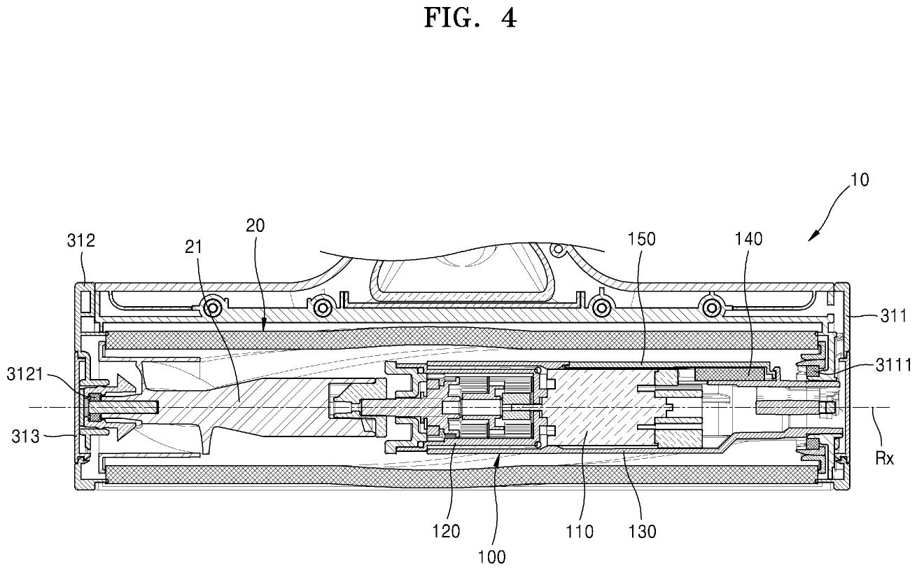

FIG. 2 is a perspective view of a assembled cleaner head according to an embodiment of the disclosure. FIG. 3 is an exploded perspective view of a cleaner head according to an embodiment of the disclosure. FIG. 4 is a cross-sectional view of a cleaner head of FIG. 3 according to an embodiment of the disclosure.

Referring to FIGS. 2, 3, and 4, the cleaner head 10 includes a brush drum 20, a brush case 30, and a drive assembly 100.

The brush drum 20 is rotatable about a rotation axis receive (RX), and has a drum structure. The brush drum 20 may separating foreign substances from a surface to be cleaned, by repeatedly contacting the surface to be cleaned while rotating.

The brush case 30 provides a brush chamber 310 that accommodates the brush drum 20. The brush case 30 includes a first support 311 and a second support 312 arranged at both ends of the brush drum 20 in the direction of the rotation axis RX. The first support 311 and the second support 312 support the brush drum 20 to be rotatable. Bearings 3111 and 3121 that support the brush drum 20 are arranged on the first support 311 and the second support 312, respectively. The second support 312 may be detachably assembled to the brush case 30. A cap cover 313 may be assembled to the second support 312.

The drive assembly 100 is for providing a rotational force to the brush drum 20, and includes a drive motor 110 and a drive housing 130. The drive assembly 100 may further include a drive gear unit 120 that converts the rotational speed of the drive motor 110 to transmit a rotational force to the brush drum 20.

The drive motor 110 is arranged inside the brush drum 20 and provides a rotational force to the brush drum 20. The drive motor 110 may be a small motor that may be arranged inside the brush drum 20. For example, the diameter of the drive motor 110 may be 40 mm or less.

The drive motor 110 may be a direct current motor. The drive motor 110 may be a permanent magnet direct current motor (PMDC) motor. However, the type of the drive motor 110 is not limited thereto, and the drive motor 110 may be a small-sized motor that may be arranged inside the brush drum 20. For example, the drive motor 110 may be a universal motor.

A rotation shaft of the drive motor 110 is connected to the drive gear unit 120, and the rotational force of the drive motor 110 is transmitted to the drive gear unit 120. The rotational speed is converted by the drive gear unit 120, and a rotational force is transmitted to the brush drum 20.

The drive housing 130 accommodates the drive motor 110 and the drive gear unit 120, and is arranged between the inner circumferential surface of the brush drum 20 and the outer circumferential surface of the drive motor 110. The drive housing 130 is supported by the first support 311, which is an end of the brush case 30. A drive shaft of the drive motor 110 accommodated in the drive housing 130 is arranged concentrically with the rotation axis RX of the brush drum 20.

One end of the brush drum 20 is rotatably supported by a bearing 3111 supported by the first support 311, and another end is rotatably supported by a bearing 3121 arranged in the second support 312. The brush drum 20 rotates by receiving the driving force of the drive motor 110 through a driving force input unit 21 and the drive gear unit 120.

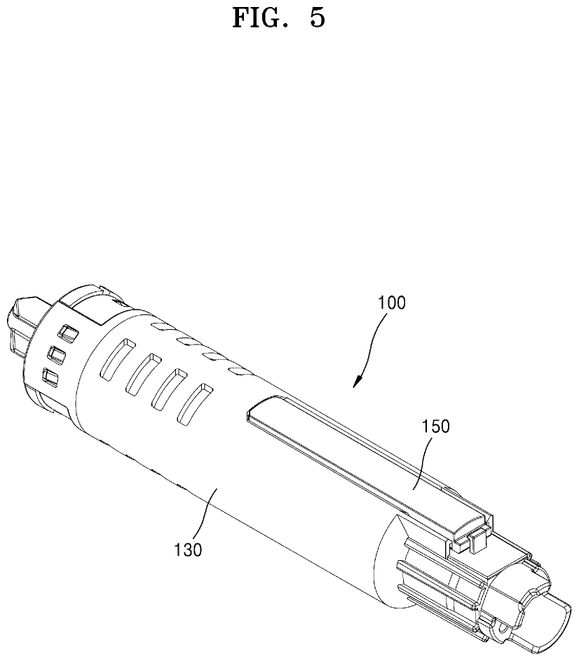

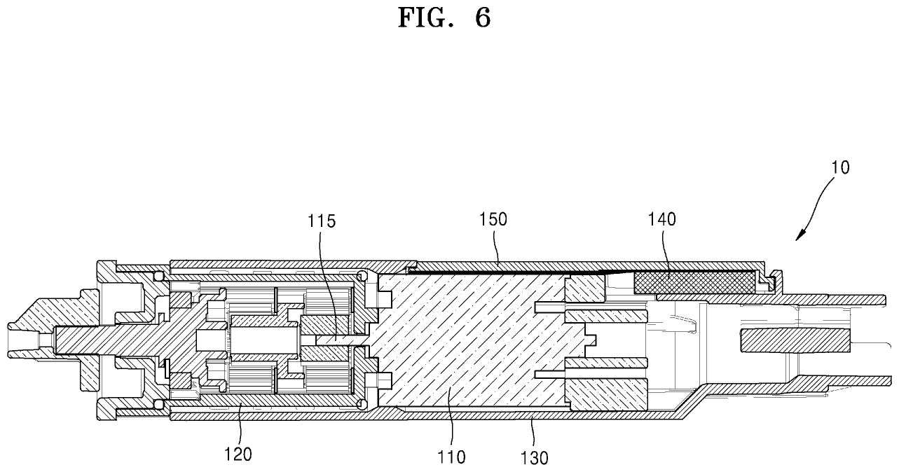

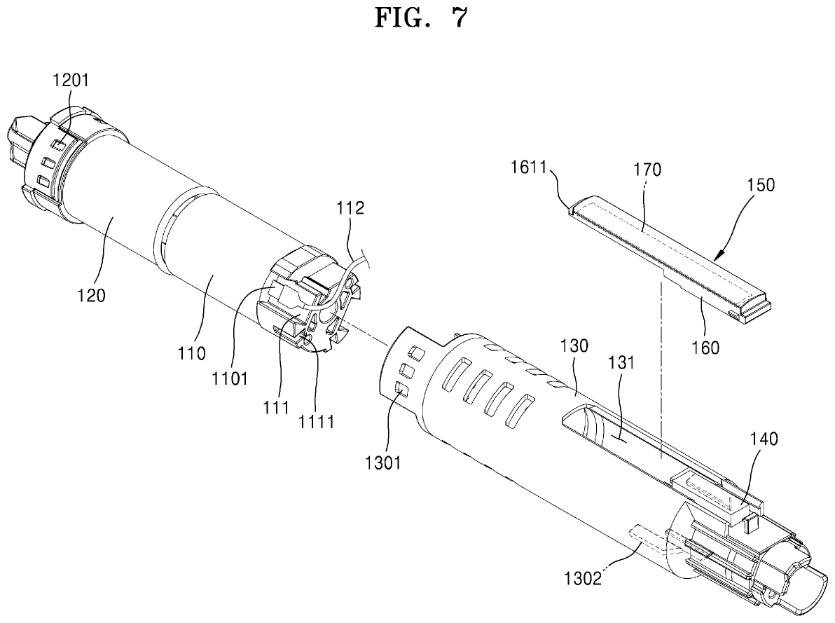

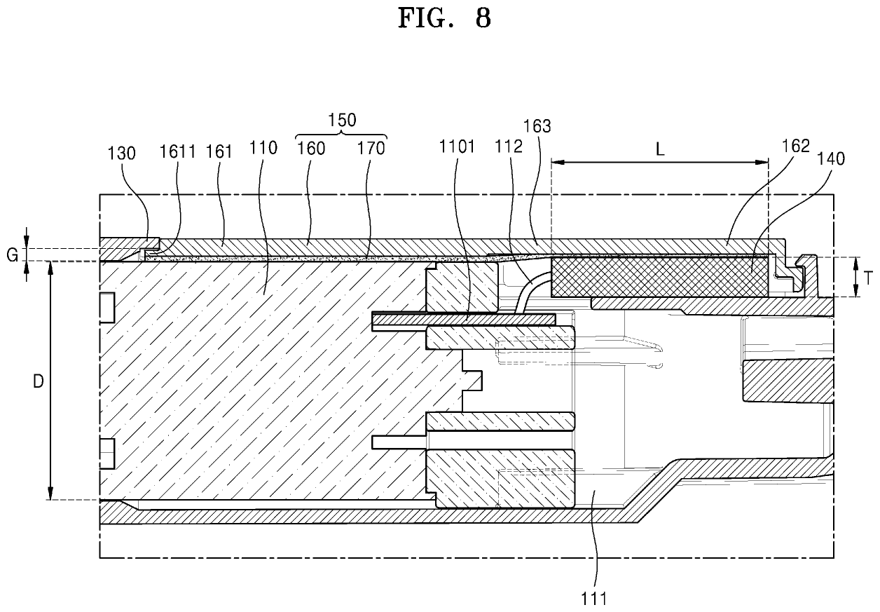

FIG. 5 is a perspective view illustrating a drive assembly according to an embodiment of the disclosure. FIG. 6 is a cross-sectional view of a drive assembly of FIG. 5 according to an embodiment of the disclosure. FIG. 7 is an exploded perspective view of a drive assembly of FIG. 5 according to an embodiment of the disclosure. FIG. 8 is an enlarged view of a portion of FIG. 6 according to an embodiment of the disclosure.

Referring to FIGS. 5, 6, and 7, the drive assembly 100 may include the drive motor 110, the drive housing 130, a thermostat 140, and a heat transfer structure 150.

The drive gear unit 120 is arranged at a front end of the drive motor 110 where a drive shaft 115 is arranged, and the drive motor 110 is assembled to the drive gear unit 120. The drive motor 110 assembled with the drive gear unit 120 may be inserted through an opening formed at an end of the drive housing 130.

The drive gear unit 120 and the drive motor 110 both inserted into the drive housing 130 may be provided with a rotation prevention member to prevent them from rotating with respect to the drive housing 130. For example, the drive gear unit 120 may be provided with a plurality of rotation prevention protrusions. A first rotation prevention protrusion 1201 of the drive gear unit 120 may be inserted into a first rotation prevention groove 1301 of the drive housing 130 to prevent rotation of the drive gear unit 120. For example, a housing coupling unit 111 having a rotation prevention groove formed thereon may be arranged at a rear end of the drive motor 110. When the drive motor 110 is inserted into the drive housing 130, a rotation prevention rib 1302 provided on the inner circumferential surface of the drive housing 130 may be inserted into a second rotation prevention groove 1111 of the housing coupling unit 111 to prevent the drive motor 110 from rotating with respect to the drive housing 130.

As the drive motor 110 inserted into the drive housing 130 rotates, the rotational force of the drive motor 110 is transmitted to the brush drum 20 through the drive gear unit 120.

However, depending on the condition of a floor, the load on the brush drum 20 increases, and accordingly, heat may be generated in the drive motor 110 providing the rotational force to the brush drum 20. As the load on the brush drum 20 increases, overheating may occur in the drive motor 110, which may lead to a fire or damage to the drive motor 110 or its peripheral components.

The thermostat 140 cuts off power supplied to the drive motor 110 according to the temperature, in order to prevent overheating of the drive motor 110. To this end, the thermostat 140 may be arranged between the drive motor 110 and a power supply unit (not shown) that supplies power to the drive motor 110, and may be configured to block the electrical connection between the drive motor 110 and the power supply unit according to the temperature. For example, the thermostat 140 may be electrically connected to a terminal 1101 of the drive motor 110 by a wire 112.

The thermostat 140 may cut off power supply according to the ambient temperature. For example, the thermostat 140 may cut off the power supply when the temperature of the drive motor 110 is greater than a predetermined temperature. The thermostat 140 may have a structure using a bimetal, but is not limited thereto, and may be modified in various ways as long as it is capable of cutting off power according to a temperature condition.

Referring to FIGS. 6 and 8, the thermostat 140 may have a certain size. For example, a thickness T of the thermostat 140 may be greater than a gap G between the drive housing 130 and the drive motor 110. Here, the gap G between the drive housing 130 and the drive motor 110 may be in a direction perpendicular to the direction of the rotation axis. A length L of the thermostat 140 may be 0.3 to 2 times a diameter D of the drive motor 110. For example, the thermostat 140 may have a thickness T of 3 mm to 10 mm and a length L of 10 mm to 50 mm.

The thermostat 140 may be arranged to be spaced apart from the drive motor 110 in the direction in which the rotation axis extends. By arranging the thermostat 140 to be spaced apart from the drive motor 110, it is possible to prevent the size of the drive housing 130 from increasing depending on the thickness T of the thermostat 140. Accordingly, an increase in the size of the brush drum 20 may be prevented.

When, unlike the embodiment of the disclosure, the thermostat 140 is arranged on the outer circumferential surface of the drive motor 110, the size of the drive housing 130 surrounding the drive motor 110 increases due to the thickness T of the thermostat 140, which results in an increase in the size of the brush drum 20. Here, the difference between the inner diameter of the drive housing 130 and the outer diameter of the drive motor 110 may be greater than or equal to the thickness T of the thermostat 140.

In contrast, in the embodiment of the disclosure, because the thermostat 140 is not arranged on the outer circumferential surface of the drive motor 110 but is arranged to be spaced apart from the drive motor 110, the size of the drive housing 130 may be reduced. For example, the difference between the inner diameter of the drive housing 130 and the outer diameter of the drive motor 110 may be less than the thickness T of the thermostat 140.

The heat transfer structure 150 is configured to transfer heat from the drive motor 110 to the thermostat 140 spaced apart from the drive motor 110. The heat transfer structure 150 extends along the direction of the rotation axis, and includes a heat transfer plate 160 assembled to the drive housing 130.

The heat transfer plate 160 includes a material with high thermal conductivity. For example, the heat transfer plate 160 may include a material with thermal conductivity higher than that of the material of the drive housing 130. For example, the heat transfer plate 160 may include a metal with excellent thermal conductivity. For example, the heat transfer plate 160 may include aluminum (Al), but is not limited thereto, and may include a variety of materials as long as they have excellent thermal conductivity.

When the temperature of the drive motor 110 rises to be greater than the temperature of the thermostat 140, the heat transfer plate 160 transfers heat from the drive motor 110 to the thermostat 140.

The heat transfer plate 160 may include a first area 161 overlapping the drive motor 110, a second area 162 overlapping the thermostat 140, and a connection area 163 connecting the first area 161 to the second area 162. Accordingly, heat generated in the drive motor 110 may be transferred to the thermostat 140 through the first area 161, the connection area 163, and the second area 162.

Referring again to FIGS. 5, 6, and 7, the heat transfer plate 160 may be configured to be assembled to the drive housing 130. For example, the drive housing 130 may include a cutout 131 that exposes a portion of the drive motor 110. The heat transfer plate 160 may be inserted into and coupled to the cutout 131 of the drive housing 130. By coupling the heat transfer plate 160 to the cutout 131 of the drive housing 130, the heat transfer plate 160 may thermally connect the drive motor 110 to the thermostat 140.

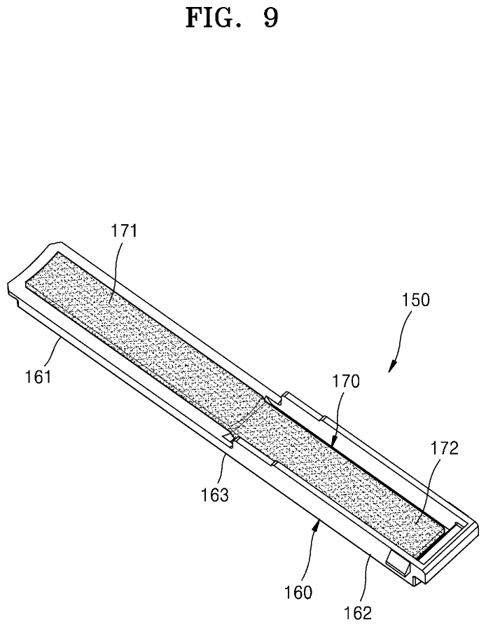

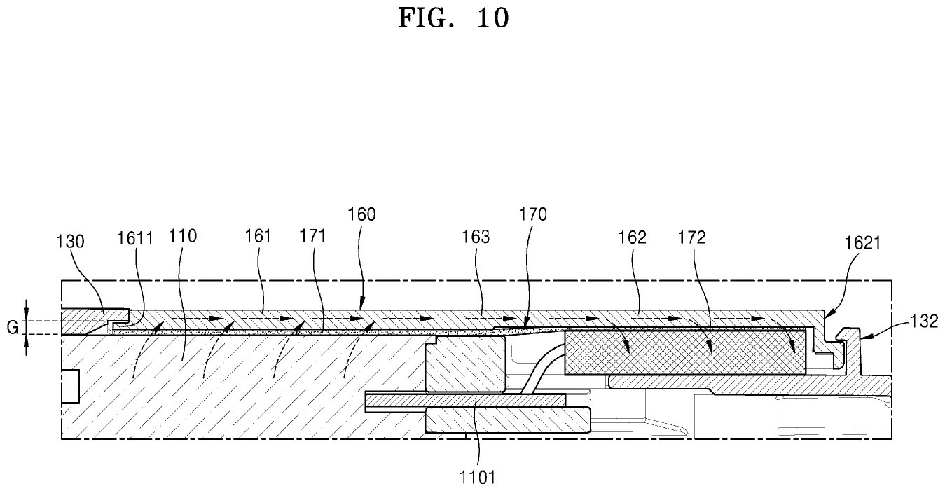

FIG. 9 is a perspective view of a heat transfer structure of FIG. 7 viewed from another angle according to an embodiment of the disclosure. FIG. 10 is a diagram illustrating a path of heat transfer by a heat transfer structure according to an embodiment of the disclosure.

Referring to FIGS. 8 and 9, the heat transfer structure 150 may further include a connection pad 170. The connection pad 170 may transfer heat from the drive motor 110 to the heat transfer plate 160 and transfer heat from the heat transfer plate 160 to the thermostat 140, by considering the thermal resistance between the drive motor 110 and the heat transfer plate 160, and the thermal resistance between the heat transfer plate 160 and the thermostat 140.

The connection pad 170 is elastically deformable and may adhere the heat transfer plate 160 to the drive motor 110 and the thermostat 140. For example, the connection pad 170 includes a first adhesion area 171 adhered to the drive motor 110, and a second adhesion area 172 adhered to the thermostat 140.

Referring to FIG. 10, heat from the drive motor 110 is transferred to the first area 161 of the heat transfer plate 160 through the first adhesion area 171. The heat transferred to the first area 161 is transferred along the connection area 163 and the second area 162 of the heat transfer plate 160. The heat transferred to the second area 162 of the heat transfer plate 160 is transferred to the thermostat 140 through the second adhesion area 172 of the connection pad 170. Even though the thermostat 140 and the drive motor 110 are arranged to be spaced apart from each other, heat is transferred by the heat transfer plate 160 and the connection pad 170 both having high thermal conductivity, and thus, the thermostat 140 may operate according to the temperature of the drive motor 110. Thus, when the drive motor 110 overheats, the thermostat 140 may cut off the power supplied to the drive motor 110.

Meanwhile, the heat transfer structure 150 may be assembled to the drive housing 130 after the drive motor 110 is assembled inside the drive housing 130. The heat transfer plate 160 may be configured to be assembled to the drive housing 130 considering the adhesiveness of the connection pad 170.

For example, the heat transfer plate 160 may be assembled to the drive housing 130 by rotatably assembling one end of the heat transfer plate 160 to the drive housing 130, and then rotating the heat transfer plate 160 such that the other end of the heat transfer plate 160 approaches the drive housing 130.

The heat transfer plate 160 may include a step area 1611 arranged at one end, and a coupling area 1621 arranged at the other end. The thickness of the step area 1611 may be less than or equal to the gap between the drive housing 130 and the drive motor 110. Accordingly, the step area 1611 may be inserted between the drive housing 130 and the drive motor 110. The coupling area 1621 may be assembled to a second coupling area 132 of the drive housing 130.

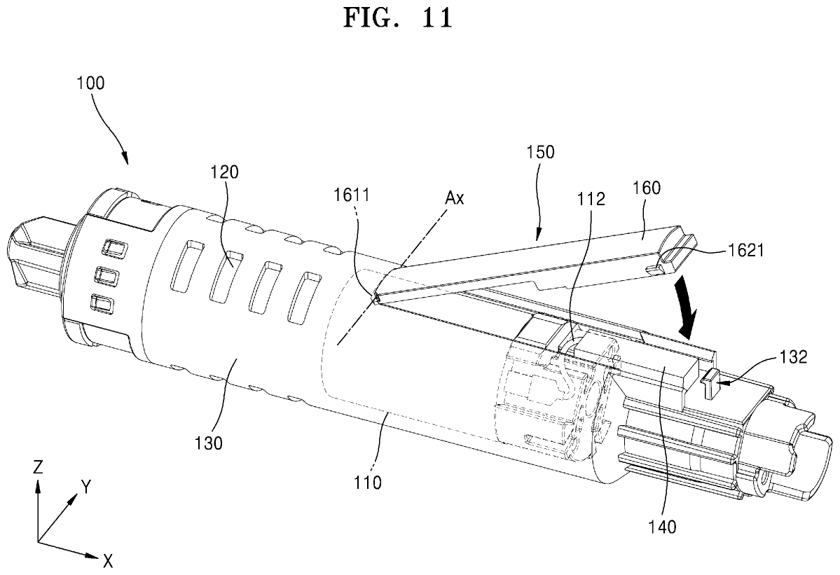

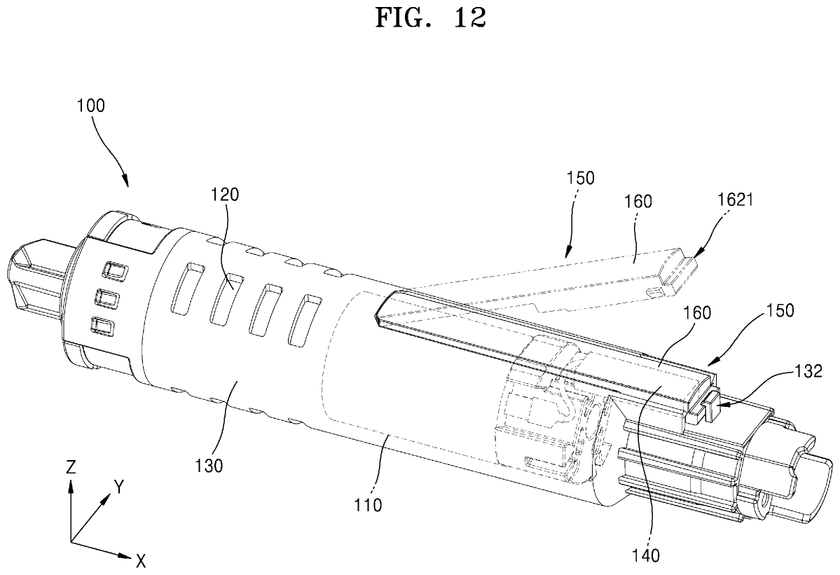

FIGS. 11 and 12 are perspective views illustrating a process of assembling a heat transfer structure to a drive housing according to various embodiments of the disclosure.

Referring to FIG. 11, it illustrates a state in which the drive motor 110 is inserted into the drive housing 130 and the drive motor 110 and the thermostat 140 are spaced apart from each other and electrically connected to each other by the wire 112.

The heat transfer plate 160 is tilted relative to the drive housing 130, and then the step area 1611 is inserted between the drive motor 110 and the drive housing 130. Because the step area 1611 has been inserted between the drive motor 110 and the drive housing 130, the heat transfer plate 160 is rotatable based on an imaginary rotation axis AX formed in the step area 1611.

Referring to FIGS. 10 and 12, in this state, the heat transfer plate 160 is rotated such that the coupling area 1621 of the heat transfer plate 160 approaches the drive housing 130. As the heat transfer plate 160 rotates, the connection pad 170 arranged inside the heat transfer plate 160 is sequentially adhered to the drive motor 110 and the thermostat 140. The coupling area 1621 is coupled to the second coupling area 132 of the drive housing 130.

Accordingly, as the coupling area 1621 of the heat transfer plate 160 is coupled to the second coupling area 132 of the drive housing 130, the heat transfer plate 160 may be coupled to the drive housing 130 so as not to deviate in a length direction X, a width direction Y, and a thickness direction Z.

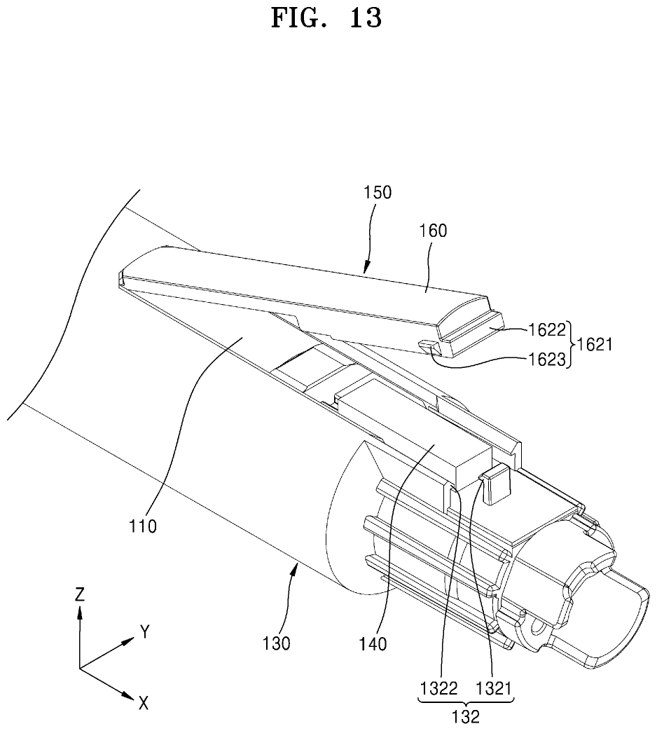

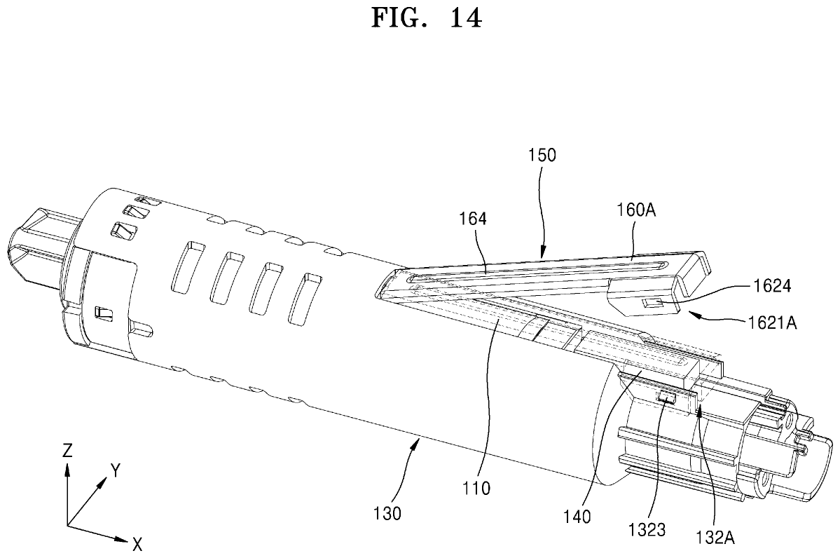

FIG. 13 is a diagram illustrating a coupling area of a heat transfer plate, and a second coupling area according to an embodiment of the disclosure. FIG. 14 is a diagram illustrating coupling areas of a heat transfer plate, and a second coupling area according to an embodiment of the disclosure.

Referring to FIG. 13, the coupling area 1621 of the heat transfer plate 160 may include a first coupling member 1622 and second coupling members 1623. The first coupling member 1622 may be arranged at an outermost portion of the other end of the heat transfer plate 160, and the second coupling members 1623 may be arranged on both sides of the other end of the heat transfer plate 160.

The second coupling area 132 of the drive housing 130 may include a first separation prevention part 1321 and second separation prevention parts 1322. The first separation prevention part 1321 is arranged to correspond to the first coupling member 1622, and the second separation prevention parts 1322 are arranged to correspond to the second coupling members 1623.

The first separation prevention part 1321 may have a hook shape to prevent separation of the first coupling member 1622 in the length direction X and the thickness direction Z of the heat transfer plate 160. The second separation prevention parts 1322 may have a hook shape to prevent separation of the second coupling members 1623 in the width direction (Y) and the thickness direction (Z) of the heat transfer plate 160. However, the shapes of the first separation prevention part 1321 and the second separation prevention part 1322 are not limited thereto and may vary depending on the shapes of the first coupling member 1622 and the second coupling member 1623.

In a process of rotating the heat transfer plate 160, the first coupling member 1622 and the second coupling members 1623 of the heat transfer plate 160 are connected to the first separation prevention part 1321 and the second separation prevention parts 1322 of the drive housing 130, respectively, and thus, the heat transfer plate 160 is coupled to the drive housing 130.

However, the coupling structure between the coupling area 1621 of the heat transfer plate 160 and the second coupling area 132 of the drive housing 130 is not limited thereto and may be implemented in various ways.

Referring to FIG. 14, the second coupling area 132A of the drive housing 130 may be implemented such that a first separation prevention part and a second separation prevention part are integrated into one component. For example, the second coupling area 132A may include coupling protrusions 1323 provided to be assembled to the drive housing 130. The coupling areas 1621A of the heat transfer plate 160A may be provided at both ends of the heat transfer plate 160A in the width direction Y, and may each include a coupling groove 1624 into which the coupling protrusion 1323 may be inserted. Accordingly, in a process of rotating the heat transfer plate 160A with respect to one end thereof, as the coupling protrusions 1323 of the second coupling area 132A are inserted into the coupling grooves 1624 of the coupling areas 1621A, the heat transfer plate 160A may be coupled to the drive housing 130 so as not to deviate in the length direction X, the width direction Y, and the thickness direction Z. The heat transfer plate 160A may further include a robustness reinforcement unit 164. The robustness of the heat transfer plate 160A may be reinforced through the robustness reinforcement unit 164.

For the purposes of promoting understanding of the disclosure, reference numerals are used in the preferred embodiments illustrated in the drawings, and particular terms are used to describe the embodiments of the disclosure, however, the disclosure is not limited by the terms and should be construed to encompass all components that would normally occur to those skilled in the art.

Particular executions described herein are merely examples and do not limit the scope of the disclosure in any way. For the sake of brevity, related-art electronics, control systems, software and other functional aspects of the systems may not be described in detail. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the disclosure unless the item or component is specifically described as being “essential” or “critical”. As used herein, the term, such as “comprising”, “including” and the like are used to be understood as being an open-ended term for description.

The use of the terms “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The disclosure is not limited to the described order of the operations. The use of any and all examples, is intended merely to better illuminate the disclosure and does not pose a limitation on the scope of the disclosure unless otherwise claimed. Furthermore, various changes and modifications will be readily apparent to one of ordinary skill in the art without departing from the spirit and scope of the disclosure.

According to the above-described embodiments of the disclosure, there may be provided a cleaner head capable of implementing a brush drum with a compact size while preventing overheating of a drive motor, and a cleaner including the cleaner head.

A cleaner head according to an embodiment of the disclosure may include a brush drum rotatable about a rotation axis, a brush case rotatably supporting the brush drum, and a drive assembly arranged inside the brush drum and configured to provide a rotational force to the brush drum, wherein the drive assembly includes a drive motor, a drive housing that accommodates the drive motor, is arranged between an inner circumferential surface of the brush drum and an outer circumferential surface of the drive motor, and is supported by an end of the brush case, a thermostat that is configured to cut off power supplied to the drive motor according to a temperature, and is arranged to be spaced apart from the drive motor in a direction of the rotation axis, and a heat transfer structure configured to transfer heat from the drive motor to the thermostat.

The heat transfer structure may include a heat transfer plate extending in the direction of the rotation axis, and assembled to the drive housing.

The heat transfer plate may extend in the direction of the rotation axis, and may include a material with thermal conductivity higher than a material of the drive housing.

The heat transfer plate may include a first area overlapping the drive motor, a second area overlapping the thermostat, and a connection area connecting the first area to the second area.

The heat transfer structure may further include a connection pad that transfers heat from the drive motor to the heat transfer plate, and transfers heat from the heat transfer plate to the thermostat.

The connection pad may be elastically deformable and may include a first adhesion area adhered to the drive motor, and a second adhesion area adhered to the thermostat.

The drive housing may include a cutout that exposes a portion of the drive motor, and the heat transfer plate may be arranged to be inserted into the cutout.

The heat transfer plate may include a step area arranged at one end thereof to be inserted between the drive housing and the drive motor, and a coupling area arranged at the other end to be coupled to the drive housing.

The drive housing may include a second coupling area assembled to the coupling area to prevent separation of the heat transfer plate.

The second coupling area may include a first separation prevention part that prevents separation of the heat transfer plate in a length direction, and second separation prevention parts that prevent separation of the heat transfer plate in a width direction.

The second coupling area may have a hook shape to prevent separation of the heat transfer plate in a thickness direction.

The coupling area may include coupling grooves provided at both ends of the heat transfer plate in the width direction, and the second coupling area may include coupling protrusions that are insertable into the coupling grooves.

The difference between an inner diameter of the drive housing and an outer diameter of the drive motor may be less than the thickness of the thermostat.

The drive motor may be a direct current electric motor.

A cleaner according to an embodiment of the disclosure may include a cleaner main body and a cleaner head connected to the cleaner main body, wherein the cleaner head includes: a brush drum rotatable about a rotation axis, a brush case rotatably supporting the brush drum, and a drive assembly arranged inside the brush drum and configured to provide a rotational force to the brush drum, and the drive assembly includes a drive motor, a drive housing that accommodates the drive motor, is arranged between an inner circumferential surface of the brush drum and an outer circumferential surface of the drive motor, and is supported by an end of the brush case, a thermostat that is configured to cut off power supplied to the drive motor according to a temperature, and is arranged to be spaced apart from the drive motor in a direction of the rotation axis, and a heat transfer structure configured to transfer heat from the drive motor to the thermostat.

The cleaner head and the cleaner according to the above-described embodiments of the disclosure may prevent overheating of a drive motor and implement a brush drum with a compact size.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A cleaner head comprising:
a brush drum rotatable about a rotation axis;
a brush case rotatably supporting the brush drum; and
a drive assembly arranged inside the brush drum and configured to provide a rotational force to the brush drum,
wherein the drive assembly comprises:
a drive motor,
a drive housing that accommodates the drive motor, is arranged between an inner circumferential surface of the brush drum and an outer circumferential surface of the drive motor, and is supported by an end of the brush case,
a thermostat that is configured to cut off power supplied to the drive motor according to a temperature, and is arranged to be spaced apart from the drive motor in a direction of the rotation axis, and
a heat transfer structure configured to transfer heat from the drive motor to the thermostat.

2. The cleaner head of claim 1, wherein the heat transfer structure comprises a heat transfer plate extending in the direction of the rotation axis, and assembled to the drive housing.

3. The cleaner head of claim 2, wherein the heat transfer plate extends in the direction of the rotation axis, and comprises a material with thermal conductivity higher than a material of the drive housing.

4. The cleaner head of claim 2, wherein the heat transfer plate comprises:
a first area overlapping the drive motor;
a second area overlapping the thermostat; and
a connection area connecting the first area to the second area.

5. The cleaner head of claim 2, wherein the heat transfer structure further comprises a connection pad that:
transfers heat from the drive motor to the heat transfer plate; and
transfers heat from the heat transfer plate to the thermostat.

6. The cleaner head of claim 5, wherein the connection pad is elastically deformable and comprises:
a first adhesion area adhered to the drive motor; and
a second adhesion area adhered to the thermostat.

7. The cleaner head of claim 2,
wherein the drive housing comprises a cutout that exposes a portion of the drive motor, and
wherein the heat transfer plate is arranged to be inserted into the cutout.

8. The cleaner head of claim 7, wherein the heat transfer plate comprises:
a step area arranged at one end thereof to be inserted between the drive housing and the drive motor; and
a coupling area arranged at other end to be coupled to the drive housing.

9. The cleaner head of claim 8, wherein the drive housing comprises a second coupling area assembled to the coupling area to prevent separation of the heat transfer plate.

10. The cleaner head of claim 9, wherein the second coupling area comprises:
a first separation prevention part that prevents separation of the heat transfer plate in a length direction; and
second separation prevention parts that prevent separation of the heat transfer plate in a width direction.

11. The cleaner head of claim 10, wherein the second coupling area has a hook shape to prevent separation of the heat transfer plate in a thickness direction.

12. The cleaner head of claim 10,
wherein the coupling area comprises coupling grooves provided at both ends of the heat transfer plate in the width direction, and
wherein the second coupling area comprises coupling protrusions that are insertable into the coupling grooves.

13. The cleaner head of claim 1, wherein a difference between an inner diameter of the drive housing and an outer diameter of the drive motor is less than a thickness (T) of the thermostat.

14. The cleaner head of claim 1, wherein the drive motor is a direct current electric motor.

15. A cleaner comprising:
a cleaner main body; and
a cleaner head connected to the cleaner main body,
wherein the cleaner head comprises:
a brush drum rotatable about a rotation axis,
a brush case rotatably supporting the brush drum, and
a drive assembly arranged inside the brush drum and configured to provide a rotational force to the brush drum, and
wherein the drive assembly comprises:
a drive motor,
a drive housing that accommodates the drive motor, is arranged between an inner circumferential surface of the brush drum and an outer circumferential surface of the drive motor, and is supported by an end of the brush case,
a thermostat that is configured to cut off power supplied to the drive motor according to a temperature, and is arranged to be spaced apart from the drive motor in a direction of the rotation axis, and
a heat transfer structure configured to transfer heat from the drive motor to the thermostat.
